(19) United States
(12) Patent Application Publication
(10) Pub. No.: US 2008/0057783 A1
(43) Pub. Date: Mar. 6, 2008

(54) Coaxial cable connecting board, converter, and high frequency apparatus

(75) Inventor: Hiroyuki Dohata, Osaka (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/889,594

(22) Filed: Aug. 15, 2007

(30) Foreign Application Priority Data
Sep. 1, 2006 (JP) 2006-238144

(51) Int. Cl. H01R 9/05

(52) U.S. Cl. 439/581; 333/21 A

(57) ABSTRACT

A connecting board 1 includes a ground pattern 3, electrically connected, which is formed on a surface of the connecting board 1. The ground pattern 3, in which an outer conductor of a semi-rigid cable 2 is soldered, is larger than each of soldering sections 6 where soldering is carried out. On this connecting board 1, a slit 7 is formed by paring off a periphery of the soldering section 6 so that the ground pattern 3 is cut off. The outer conductor is soldered in an area of the ground pattern 3 which area is surrounded by the slit 7. This makes it possible to provide a coaxial cable connecting board onto which surface a coaxial cable can be directly soldered in a minimum essential area, a converter using the coaxial cable connecting board, and a high frequency apparatus using the coaxial cable connecting board.

This nonprovisional application claims priority under 35 U.S.C. § 119(a) on Patent Application No. 238144/2006 filed in Japan on Sep. 1, 2006, the entire contents of which are hereby incorporated by reference.

### FIELD OF THE INVENTION

The present invention relates to a coaxial cable connecting board, a converter, and a high frequency apparatus, particularly to a connecting board for connecting a semi-rigid cable, a converter using the connecting board, and a high frequency apparatus using the connecting board.

### BACKGROUND OF THE INVENTION

A coaxial cable including an inner conductor and an outer conductor is used for wiring which prevents influence of external noise. When the coaxial cable is connected to a connecting board, the outer conductor is often connected to a ground pattern by soldering so that attenuation of signals is reduced.

For an example, an LNB (Low Noise Block down converter) is used to receive satellite broadcast signals and send the signals to a tuner. Especially in recent years, satellite broadcast services are diversified. For example, multi-channel satellite service is realized. Moreover, the broadcast is carried out with the use of a plurality of satellites. Therefore, one LNB serves as a receiver for signals from the plurality of satellites or a device sending the signals to a plurality of tuners. Therefore, a circuit configuration of the LNB tends to become complicated.

As the circuit configuration becomes complicated, wirings for signals received need to be intersected each other on a connecting board or sections apart from each other need to be connected on the connecting board.

A coaxial cable is used for connection at which wirings for signals received are intersected each other on the connecting board or for connection between sections apart from each other on the connecting board. A signal cable called a semi-rigid cable is used especially for wiring of signals, for example, satellite broadcast signals.

FIG. 14 is a plan view illustrating an example of connecting a semi-rigid cable on a conventional connecting board. FIG. 15 is a plan view illustrating a back surface of the connecting board. The connecting board 101 includes a ground pattern 103 provided as a pattern, a through hole 104, a signal line 109, and the like.

The connecting board includes a through hole provided for connection with a semi-rigid cable. The through hole provided particularly for connection with a semi-rigid cable is referred to as a connecting through hole 105.

Conventionally, connection between sections apart from each other on the connecting board 101 is realized by connection with the use of a semi-rigid cable 102, as illustrated in FIG. 15.

The semi-rigid cable 102 includes an inner conductor and an outer conductor. The inner conductor transmits signals received or the like. The outer conductor is provided for prevention of influence from noise. When the semi-rigid cable 102 is connected to the substrate 101, the inner conductor is connected to the connecting through hole 105 of the connecting board and the outer conductor is connected to the ground pattern 103. This makes it possible to prevent influence from external noise. According to need, the outer conductor of the semi-rigid cable 102 is connected to the ground pattern 103 at a plurality of soldering sections 106.

Examples of a connecting method, other than the above-mentioned connecting method, for reliably connecting a connecting board with a coaxial cable are: (i) a connecting method in which a coaxial connector is provided on a connecting board, the method being disclosed in, for example, Patent Document 1 (Japanese Unexamined Patent Publication No. 26021/2005 (Tokukai 2005-26021) (published on Jan. 27, 2005)); and (ii) a connecting method in which a landing section, having a three-dimensional structure, to which a semi-rigid cable is connected is provided on a connecting board, the method being disclosed in, for example, Patent Document 2 (for example, Japanese Unexamined Patent Publication No. 145014/1998 (Tokukaihei 10-145014) (published on May 29, 1998)).

However, the conventional coaxial cable connecting board, a conventional converter, and a conventional high frequency apparatus have a problem such that the coaxial cable cannot be directly soldered in a minimum essential area on a surface of the connecting board.

As illustrated in FIGS. 14 and 15, each of the inner conductor and the outer conductor of the coaxial cable needs to be soldered to the connecting board, for reliable connection between the coaxial cable and the connecting board.

The inner conductor of the coaxial cable has a different conductor area for soldering from the outer conductor of the coaxial cable. Because particularly conductor of the outer conductor has a large volume, an area necessary for soldering of the outer conductor becomes large on the connecting board. Accordingly, an amount of solder also becomes relatively large for reliable soldering.

In the above-mentioned LNB or the like, a front surface of the connecting board often has a circuit with a coaxial line such as a microstrip line. A back surface of such a connecting board has a large ground pattern area for the purpose of preventing external noise. Connection of the outer conductor of the coaxial cable to the connecting board causes a problem such that a relatively large amount of solder used for the connection spreads on the ground pattern.

However, it is preferable that an area used for soldering is as small as possible on the connecting board because other components need to be mounted on the connecting board.

Conventionally, as a method for controlling an area used for the soldering (a size of a soldering section 106 where the coaxial cable is soldered to the ground pattern), resist or the like is provided on a periphery of an area used for the soldering so as to control an area in which the solder spreads. Alternatively, an amount of solder to be applied is adjusted.

According to the method disclosed in Patent Document 1, the provision of the coaxial connector on the connecting board allows soldering for connecting the coaxial cable with the connecting board to be carried out by a machine. In this case, an area necessary for the soldering is a size of the connector. However, this method needs a connector for each connection with the coaxial cable. Moreover, an additional process for attaching the connector becomes necessary at a position where the connector is provided on the connecting board.

According to the method disclosed in Patent Document 2, a landing section provided for connection of the semi-rigid cable to the connecting board has a three-dimensional structure. This allows an angle between the connecting board and the semi-rigid cable to vary. However, when the semi-rigid cable is soldered to the landing section, it is necessary to control an area where the solder spreads with the use of resist or the like, or alternatively to adjust an amount of solder to be applied, as in a conventional method.

### SUMMARY OF THE INVENTION

The present invention is attained in view of the above-mentioned conventional problems. An object of the present invention is to provide a coaxial cable connecting board on which surface a coaxial cable can be directly soldered in a minimum essential area, and a converter using the coaxial connecting board, and a high frequency apparatus using the coaxial cable connecting board.

In order to achieve the object mentioned above, a coaxial cable connecting board, on which surface a conductor area is formed, the conductor area, in which an outer conductor of a coaxial cable is soldered, being larger than a soldering area where a soldering is carried out to the outer conductor, the coaxial cable connecting board includes: a cut section, which is formed by paring off a periphery of the soldering area so that the conductor area is cut off, the outer conductor being soldered in an area of the conductor area which area is surrounded by the cut section.

A converter of the present invention, in order to achieve the above-mentioned object, uses the coaxial cable connecting board.

A high frequency apparatus of the present invention, in order to achieve the above-mentioned object, uses the coaxial cable connecting board.

According to the invention mentioned above, the coaxial cable connecting board of the present invention has a cut section that separates a conductor area on a surface of the connecting board. The cut section can control an area where solder spreads when the outer conductor is soldered to the connecting board. Therefore, the area where the solder spreads can be controlled, without providing resist or adjusting an amount of solder to be applied for the connection as in the conventional connection.

This realizes an arrangement of a converter and a high frequency apparatus using the coaxial cable connecting board on which surface a coaxial cable is soldered in a minimum essential area.

Additional objects, advantages and novel features of the invention will be set forth in part in the description which follows, and in part will become apparent to those skilled in the art upon examination of the following or may be learned by practice of the invention.

### BRIEF DESCRIPTION OF THE DRAWINGS

FIG. 1 is a plan view illustrating a back surface of a connecting board according to one embodiment of connection between a semi-rigid cable and a connecting board.

FIG. 2 is a plan view illustrating the back surface of the connecting board according to the embodiment of the connection between the semi-rigid cable and the connecting board, and magnifying a connecting section with solder in FIG. 1.

FIG. 3 is a plan view illustrating the back surface of the connecting board according to the embodiment of the connection between the semi-rigid cable and the connecting board, and illustrating the back surface of the connecting board which surface is provided with a through hole in a ground pattern surrounded by a slit on the connecting board as in FIG. 2.

FIG. 4 is a plan view illustrating a back surface of a connecting board according to another embodiment of connection between a semi-rigid cable and a connecting board, and illustrating the back surface of the connecting board which includes bridges at parts of a slit on the connecting board as in FIG. 2.

FIG. 5 is a plan view illustrating a back surface of a connecting board according to another embodiment of connection between a semi-rigid cable and a connecting board, and illustrating the back surface of the connecting board provided with a through hole at a section where the connecting board as in FIG. 2 and the semi-rigid cable overlap.

FIG. 6 is a plan view illustrating a back surface of a connecting board according to another embodiment of connection between a semi-rigid cable and a connecting board, and illustrating the back surface of the connecting board which surface is provided with a slit on the connecting board as in FIG. 2, the slit having a circular shape.

FIG. 7 is a plan view illustrating a back surface of a connecting board according to another embodiment of connection between a semi-rigid cable and a connecting board, and illustrating the back surface of the connecting board which surface is provided with a slit on the connecting board as in FIG. 2 on one side with respect to the semi-rigid cable.

FIG. 8 is a plan view illustrating a back surface of a connecting board according to another embodiment of connection between a semi-rigid cable and a connecting board, and illustrating the back surface of the connecting board on which surface slits on the connecting board as in FIG. 1, each being provided on one side with respect to the semi-rigid cable, are provided on the same side with respect to the semi-rigid cable.

FIG. 9 is a plan view illustrating a back surface of a connecting board according to another embodiment of connection between a semi-rigid cable and a connecting board, and illustrating the back surface of the connecting board on which surface slits on the connecting board as in FIG. 1, each being provided on one side with respect to the semi-rigid cable, are provided on sides different to each other with respect to the semi-rigid cable.

FIG. 10 is a plan view illustrating a back surface of a connecting board according to another embodiment of connection between a semi-rigid cable and a connecting board, and illustrating the back surface of the connecting board which is provided with bridges at parts of a slit on the connecting board as in FIG. 2 and a through hole at a section where the connecting board and the semi-rigid cable overlap.

FIG. 11 is a plan view illustrating a back surface of a connecting board according to another embodiment of connection between a semi-rigid cable and a connecting board, and illustrating the back surface of the connecting board which surface is provided with bridges at parts of a slit on the connecting board as in FIG. 7.

FIG. 12 is a plan view illustrating a back surface of a connecting board according to another embodiment of connection between a semi-rigid cable and a connecting board, and illustrating the back surface of the connecting board which surface is provided with a through hole at a section where the connecting board as in FIG. 7 and the semi-rigid cable overlap.

FIG. 13 is a plan view illustrating a back surface of a connecting board according to another embodiment of connection between a semi-rigid cable and a connecting board, and illustrating the back surface of the connecting board which surface is provided with bridges at parts of a slit on the connecting board as in FIG. 7 and a through hole at a section where the connecting board and the semi-rigid cable overlap.

FIG. 14 is a plan view illustrating a front surface of a connecting board according to an example of conventional connection between a conventional semi-rigid cable and a conventional connecting board.

FIG. 15 is a plan view illustrating a back surface of a connecting board according to an example of conventional connection between a conventional semi-rigid cable and a conventional connecting board.

### DESCRIPTION OF THE EMBODIMENTS

### Embodiment 1

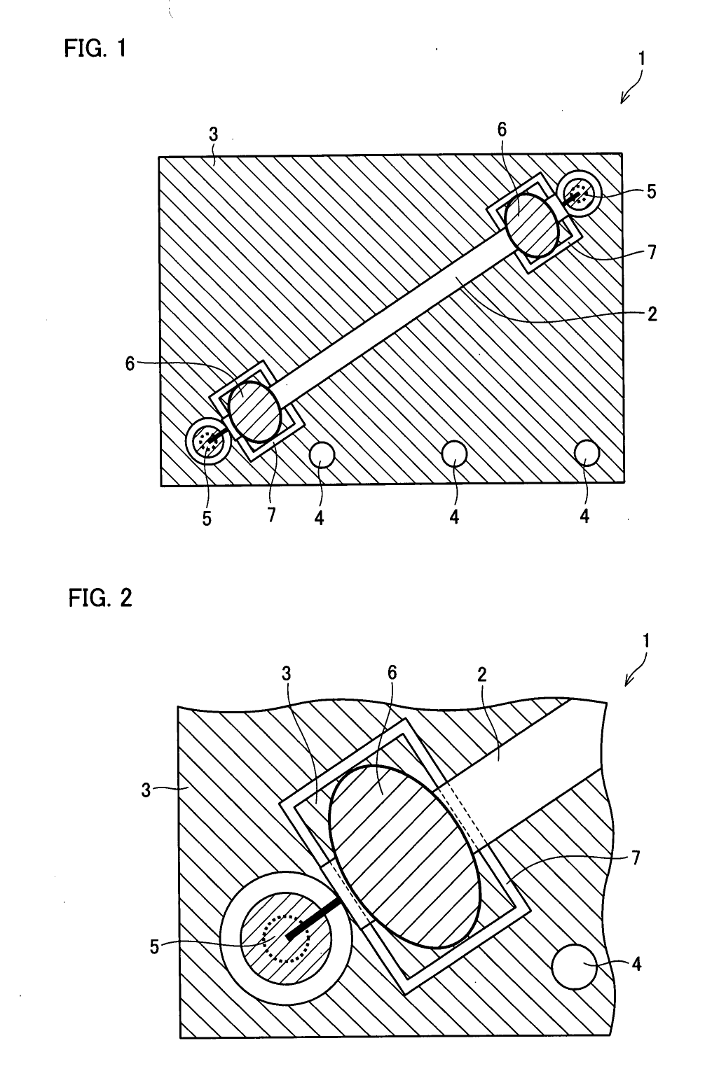

The following will explain an embodiment of the present invention with reference to FIGS. 1 and 2.

The present invention is characterized in that a layout of a connecting board includes a slit provided on a periphery of a ground pattern including a soldering section, the connecting board connecting signal lines with the use of a semi-rigid cable.

In a case where the semi-rigid cable deals with signals having a short wavelength such as a wavelength of UHF or SHF, the semi-rigid cable causes a smaller transmission loss, compared with a case where a general coaxial cable (braided wire) deals with such signals. Moreover, as to a structure, a diameter of the semi-rigid cable is smaller than that of the general coaxial cable.

FIG. 1 is a plan view illustrating a back surface of a connecting board of the present embodiment according to an example of connection with a semi-rigid cable on the connecting board. FIG. 2 is a plan view magnifying the connecting section with solder as in FIG. 1.

In the present embodiment, wiring is provided on the back surface of the connecting board with the use of a semi-rigid cable. However, the wiring is not limited to this. Alternatively, wiring may be provided on a front surface of the connecting board with the use of the semi-rigid cable. Moreover, an entire back surface of the connecting board is provided with a ground pattern (conductor area) 3. However, the wiring pattern is not limited to this. Alternatively, according to need, for example, a signal pattern may be optionally provided. Furthermore, a cable used for wiring is not specifically limited as long as an outer conductor is connected to the connecting board. An example of such a cable is a general coaxial cable.

The back surface of a connecting board 1 is provided with a ground pattern 3, through holes 4, connecting through holes 5 provided for connection with a semi-rigid cable 2, and slits (cut sections) 7.

According to the present embodiment, each of the slits 7 is provided on a periphery of a soldering section 6 where the outer conductor of the semi-rigid cable 2 is soldered to the ground pattern 3.

When the outer conductor of the semi-rigid cable 2 is soldered to the ground pattern 3, the solder spreads on the ground pattern 3 due to solder wetting characteristics.

According to a method of the present embodiment, the slit 7 is provided around the soldering section 6. The slit 7 of the present invention is a pattern of a surface of the connecting board 1. Unlike the ground pattern 3, the pattern of the slit 7 is not applied with metal or resist. Namely, according to the method of the present embodiment, solder cannot spread beyond the slit that separates the ground pattern 3 when the outer conductor of the semi-rigid cable 2 is soldered to the connecting board 1.

As a result, it becomes unnecessary to control, with the use of resist, an area where solder spreads or to adjust an amount of solder to be applied, when the outer conductor of the semi-rigid cable 2 is soldered to the ground pattern 3.

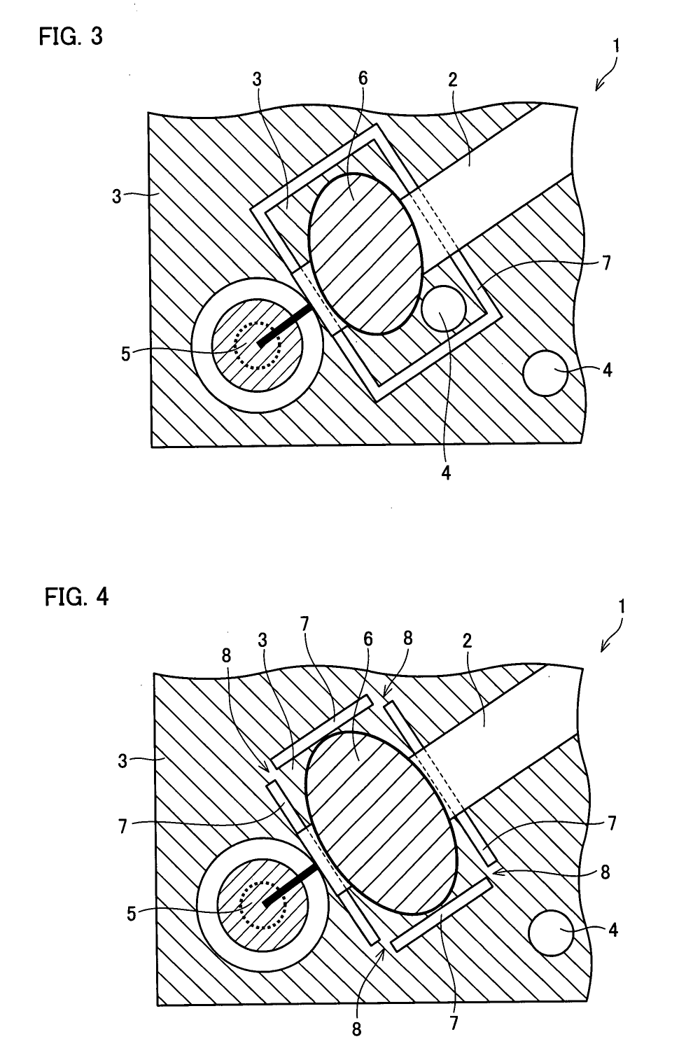

As illustrated in FIG. 3, a through hole 4 may be provided in an area surrounded by the slit 7 and used to electrically connect the ground pattern 3 surrounded by the slit 7 to a ground pattern on the front surface of the connecting board 1.

This arrangement allows earth at the soldering section 6 in which the semi-rigid cable 2 is soldered to the ground pattern 3 electrically separated by the slit 7 to be electrically connected, with the use of the through hole 4, to the ground pattern on the front surface of the connecting board 1.

In this way, according to the arrangement of the present embodiment, the outer conductor of the semi-rigid cable 2 can be connected to the ground pattern 3 in an area surrounded by the slit 7 that separates the ground pattern 3. Therefore, loss of signals at a connecting section between the semi-rigid cable 2 and the connecting board 1 can be reduced.

For example, by using the connecting board as a connecting board constituting an LNB (Low noise block down converter) used as an apparatus that receives signals for satellite broadcast and send the signals to a tuner, it becomes possible to directly solder the coaxial cable in a minimum essential area on a surface of the connecting board. This can realize production of a converter such as an LNB, or a high frequency apparatus which is resistant to external noise.

### Embodiment 2

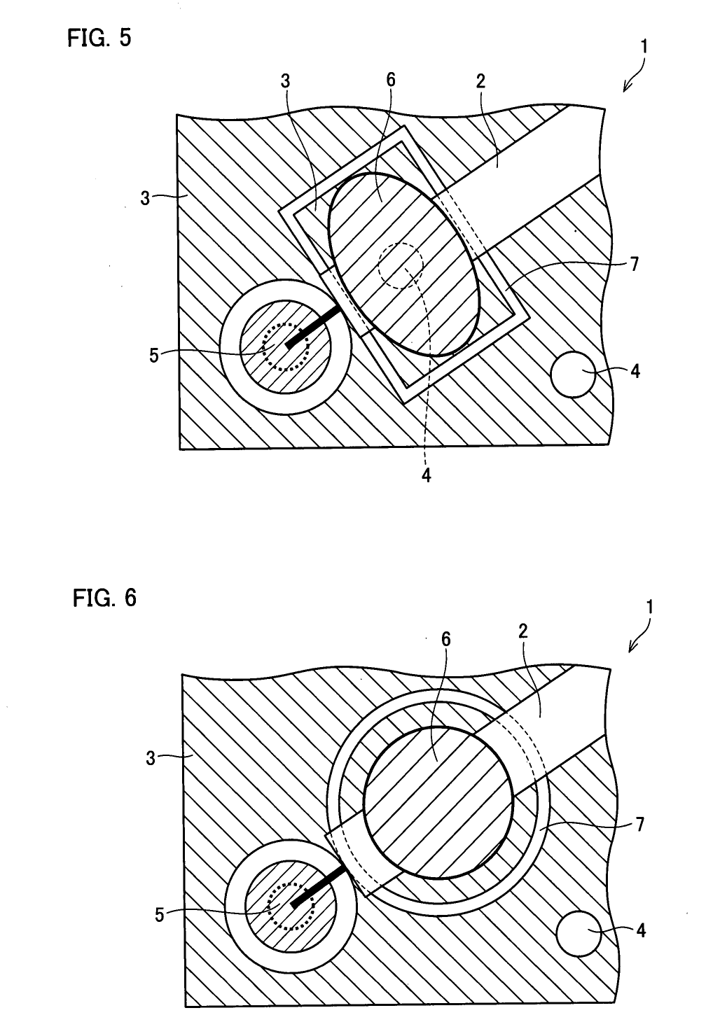

The following explains one embodiment of the present invention with reference to FIG. 4. An arrangement other than an arrangement explained in the present embodiment is the same as an arrangement in the Embodiment 1. For convenience of an explanation, members given the same reference numerals as the members explained in the Embodiment 1 respectively have identical functions and the explanations thereof are omitted.

FIG. 4 is a plan view illustrating a back surface of a connecting board and illustrating an example of connection between a semi-rigid cable and the connecting board according to the present embodiment. A connecting board 1 of the present embodiment includes bridges (connecting sections) 8 at parts of a slit 7.

Each of the bridges 8 electrically connects a ground pattern 3 surrounded by the slit 7 and a ground pattern 3 outside the slit 7, the ground pattern 3 being separated by the slit 7.

An area where solder spreads at soldering depends on solder wetting characteristics and an amount of the solder. The area also depends on a surface tension of molten solder.

According to a method of the Embodiment 1, a soldering section 6 where a semi-rigid cable is connected to the ground pattern 3 has an arrangement in which the solder does not spread beyond the slit 7.

On the other hand, according to a method of the Embodiment 2, the bridges 8 are provided to parts of the slit 7. Therefore, the ground pattern 3 surrounded by the slit 7 is not completely separated from the ground pattern 3 outside the slit 7.

As mentioned above, the area where the solder spreads depends on the solder wetting characteristic, an amount of the solder, and the surface tension of the molten solder.

In other words, appropriate adjustment of sizes of the bridges 8 makes it possible to realize an arrangement in which the solder does not spread beyond the slit 7 due to a surface tension of the molten solder.

Therefore, according to the method of the present embodiment, as with the Embodiment 1, it becomes possible to solder the coaxial cable in a minimum essential area on a surface of the connecting board. This can realize production of a converter such as an LNB, or a high frequency apparatus which is resistant to external noise.

### Embodiment 3

The following explains one embodiment of the present invention with reference to FIG. 5. An arrangement other than an arrangement explained in the present embodiment is the same as an arrangement in the Embodiment 1. For convenience of an explanation, members given the same reference numerals as the members explained in the Embodiment 1 respectively have identical functions and the explanations thereof are omitted.

FIG. 5 is a plan view illustrating a back surface of a connecting board and illustrating an example of connection between a semi-rigid cable and a connecting board according to the present embodiment. A connecting board 1 of the present embodiment is provided with a through hole 4 at a section where the connecting board 1 and a semi-rigid cable 2 overlap.

The arrangement allows earth at the soldering section 6, being electrically separated by the slit 7, where the semi-rigid cable 2 is soldered to the ground pattern 3, to be electrically connected to a ground pattern on a front surface of the connecting board 1 with the use of the through hole 4.

Moreover, the through hole 4 is not exposed on a back surface of the connecting board 1 due to the semi-rigid cable 2. Accordingly, when the semi-rigid cable 2 is soldered to the ground pattern 3, the solder does not go onto the front surface of the connecting board.

Therefore, according to the method of the present embodiment, as with the Embodiment 1, it becomes possible to solder the coaxial cable in a minimum essential area on a surface of the connecting board. This can realize production of a converter such as an LNB, or a high frequency apparatus which is resistant to external noise.

In the above-explained embodiments, a wire connected to the ground pattern is explained as a semi-rigid cable. However, as long as an outer conductor can be connected to a connecting board, the wire is not specifically limited. For example, a general coaxial cable may be used as the wire. Moreover, general application of the present embodiment is not limited to connection of the outer conductor. However, the present invention is applicable to a section where a wire or an electronic component is connected. In such a case, it is possible to carry out soldering without controlling, with the use of resist or the like, an area where the solder spreads or adjusting an amount of the solder to be applied.

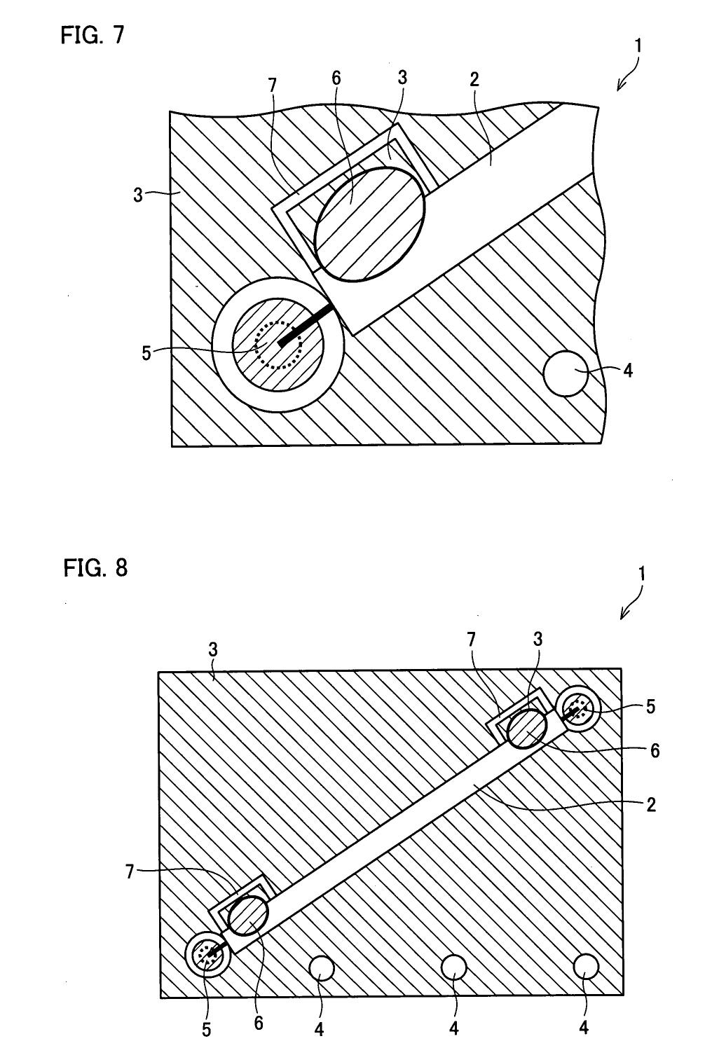

The present invention is not limited to the above-explained embodiments. However, the embodiments can be variously modified in a scope of the present invention. For example, in the above explained embodiments and drawings, a shape of the slit is described as a rectangular shape. However, the shape of the slit is not limited to this. Alternatively, the shape of the slit may be, for example, a circular shape as illustrated in FIG. 6 or other shape. Particularly when the slit has a circular shape or an arc shape, a surface tension applied to the solder at an end section of the slit becomes soft because of the circular or arc shape. This can reduce an area on which the solder spreads on the ground pattern without deteriorating surface tension of the solder which surface tension occurs at the time when the solder spreads on the ground pattern. Moreover, the slit makes it possible to appropriately change a position of the soldering section and the number of a soldering section or soldering sections. For example, a plurality of soldering sections can be provided with respect to one semi-rigid cable, as shown in FIG. 15 illustrating a conventional arrangement.

Moreover, for example, in the above-explained embodiments, soldering is carried out at both sides of the semi-rigid cable 2 over a cross section of the semi-rigid cable 2. However, a method of soldering is not specifically limited to this.

For example, as illustrated in FIG. 7, the arrangement may be such that the slit 7 is provided to only one side with respect to a center line of the cross section of the semi-rigid cable 2 on which side the semi-rigid cable 2 is soldered to the ground pattern 3. In this case, the soldering is carried out on the ground pattern 3 on a side where the slit 7 is provided with respect to the semi-rigid cable 2 and the semi-rigid cable 2.

This arrangement makes it possible to fix the soldering section 6 for connecting the ground pattern 3 and the semi-rigid cable 2 which soldering section 6 is prevented from spreading on the ground pattern 3 with the use of the slit 7.

An arrangement that is also possible is such that the ground pattern 3 surrounded by the slit 7 is not cut but connected between the semi-rigid cable 1 and the connecting board 1. In this case, the ground pattern 3 to which soldering is carried out is only partially separated by the slit 7. Therefore, connection to earth is assured. In other words, it becomes possible to prevent electrical connection from being cut between the outer conductor of the semi-rigid cable 2 and the ground pattern 3 outside the area surrounded by the slit 7. This makes it possible to strengthen the earth.

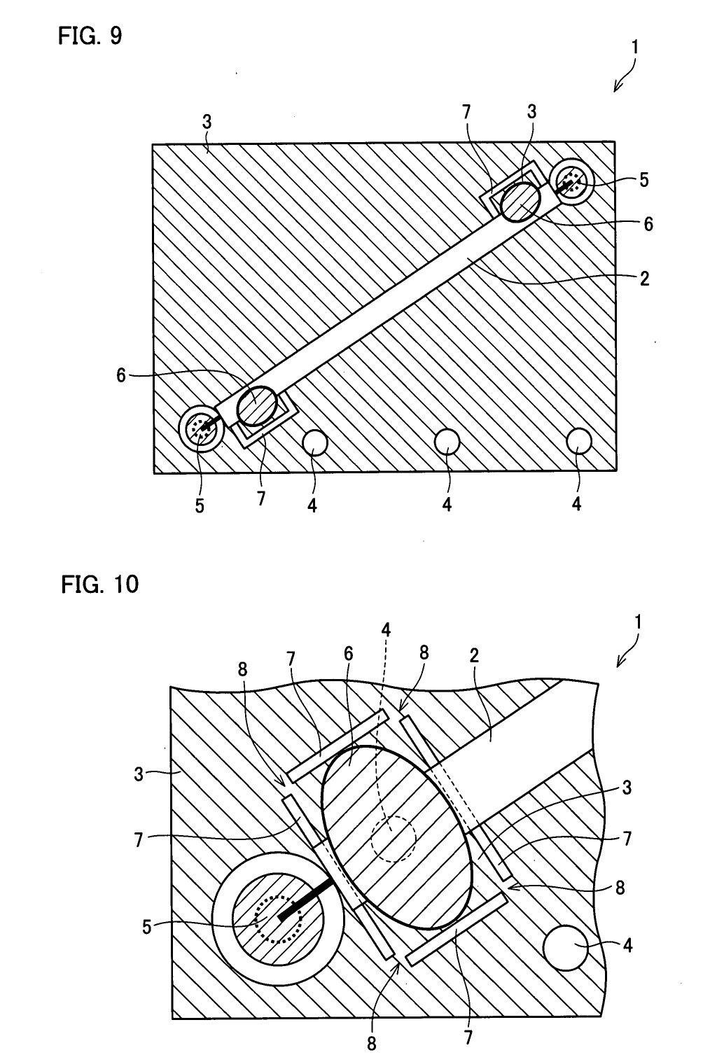

Each of the slits 7 provided to only one side with respect to the center line of the cross section of the semi-rigid cable 2 may be on the same side at both ends of the semi-rigid cable 2 as illustrated in FIG. 8. Alternatively, as illustrated in FIG. 9, the slits 7 may be provided on different sides to each other at the both ends of the semi-rigid cable 2.

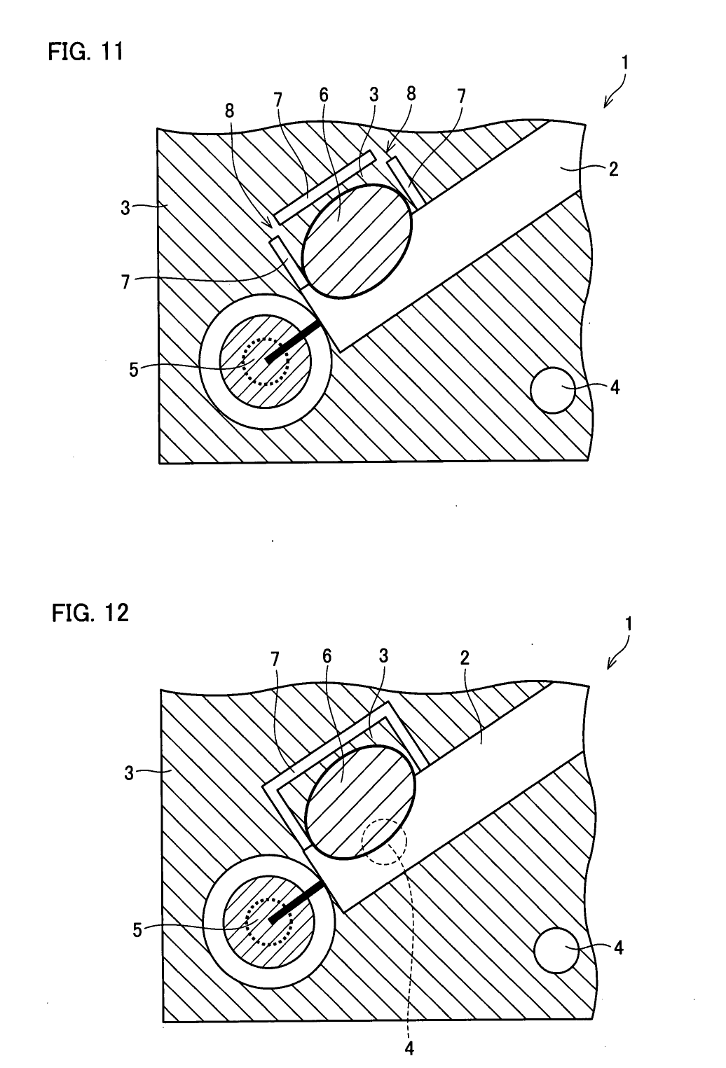

Arrangements as illustrated in FIGS. 10 through 13 are possible as combinations of the above-explained embodiments.

In FIG. 10, the connecting board 1 is provided with a through hole 4 at a section where the connecting board 1 and the semi-rigid cable 2 overlap, and also includes bridges 8 at parts of the slit 7.

In FIG. 11, the connecting board 1 is provided with a slit 7 on only one side with respect to a center line of a cross section of the semi-rigid cable 2 that is soldered to the ground pattern 3 and bridges 8 at parts of the slit 7.

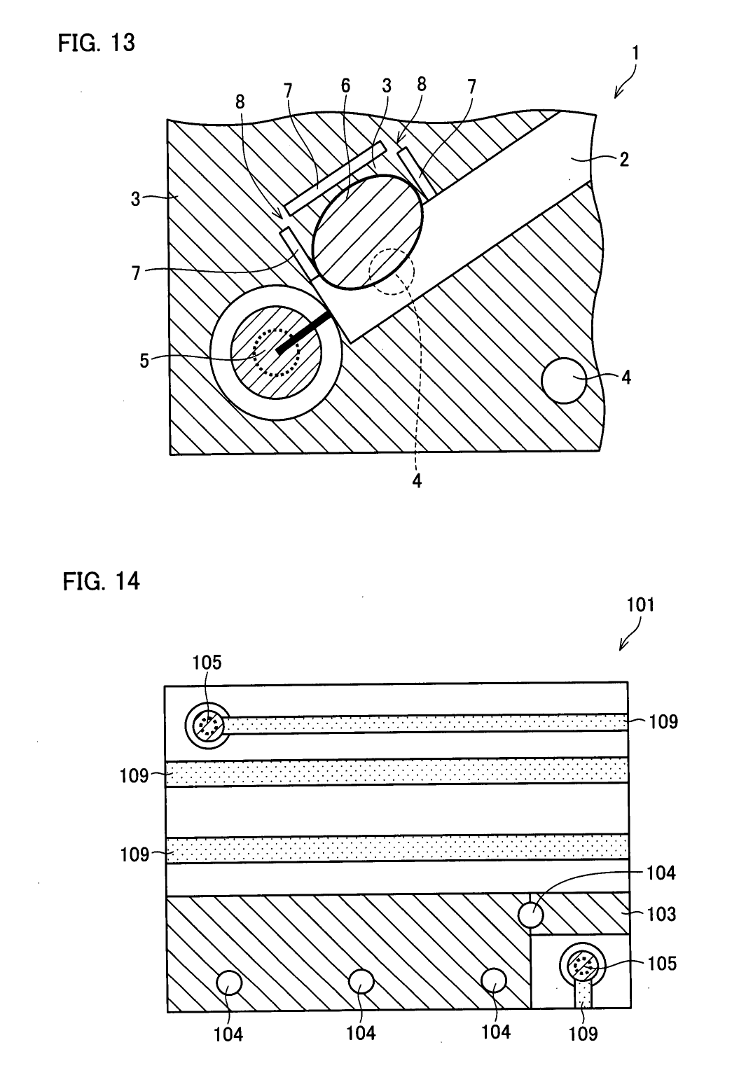

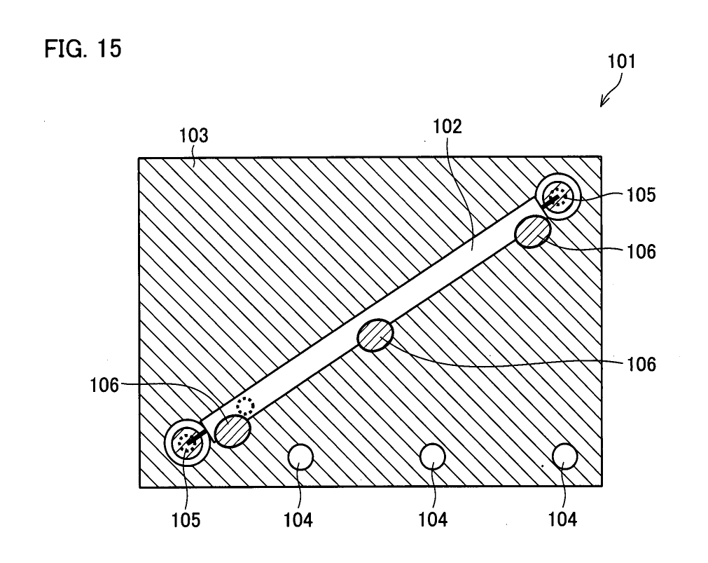

In FIG. 12, the connecting board 1 is provided with a slit 7 on only one side with respect to a center section of a cross section of the semi-rigid cable 2 that is soldered to the ground pattern 3 and a through hole 4 at a section where the connecting board 1 and the semi-rigid cable 2 overlap.

In FIG. 13, the connecting board 1 is provided with a slit 7 on only one side with respect to a center section of a cross section of the semi-rigid cable 2 that is soldered to the ground pattern 3, bridges 8 at parts of the slit 7, and a through hole 4 at a section where the connecting board 1 and the semi-rigid cable 2 overlap.

According to any one of these methods, as with the Embodiment 1, it becomes possible to solder the coaxial cable in a minimum essential area on a surface of the connecting board. Accordingly, this can realize production of a converter such as an LNB or a high frequency apparatus which is resistant to external noise.

As mentioned above, according to the present invention, because a soldering area is surrounded by a slit, solder does not spread beyond the area surrounded by the slit when soldering is carried out. Therefore, the present invention is capable of providing a coaxial cable connecting board to which surface a semi-rigid cable or a coaxial cable is directly soldered to, a converter using the connecting board, and a high-frequency apparatus using the connecting board. In addition, the present invention is applicable to a cable connecting board capable of controlling, without the use of resist or adjustment of an amount of solder to be applied, an area in which solder spreads on a section of the connecting board to which section a wire or the like is soldered, a converter using the connecting board, and a high frequency apparatus using the connecting board.

In the coaxial cable connecting board of the present embodiment, it is preferable that: a through hole is provided, which penetrates the coaxial cable connecting board between the conductor area surrounded by the cut section on one side of the coaxial cable connecting board and a surface on the other side of the coaxial cable connecting board, so that the conductor area surrounded by the cut section is electrically connected to the conductor area outside the cut section conductor area, via a conductor area on the other surface of the coaxial cable connecting board.

The arrangement makes it possible to electrically connect (i) a soldering area, where a soldering is carried out to the outer conductor, being electrically separated by the cut section from a conductor area outside the cut section, and (ii) the conductor area outside the cut section. This electrical connection is realized via (i) a through hole penetrating the connecting board so as to reach the surface on the other side of the connecting board and (ii) a conductor area on the surface on the other side of the connecting board. In other words, the soldering conductor area surrounded by the cut section can be electrically connected to the conductor area outside the cut section.

In the coaxial cable connecting board of the present embodiment, it is preferable that the soldering area is provided on one of two parts into which a cross section of the outer conductor is divided by a center line; and the soldering area is formed in at least an area surrounded by the outer conductor and the cut section.

This arrangement makes it possible to provide the soldering area to only one side with respect to a position where the outer conductor is in contact with the conductor area. In this arrangement, the conductor area surrounded by the cut section is not completely separated by the cut section from the conductor area out side the cut section. Accordingly, the arrangement allows the soldering area to be electrically connected to the conductor area outside the cut section.

In the coaxial cable connecting board of the present embodiment, it is preferable that the soldering area is plurally provided in the conductor area, and the soldering areas are provided on the same side of the conductor area with respect to a center line of the outer conductor. Moreover, in the coaxial cable connecting board of the present embodiment, the soldering area is plurally provided in the conductor area, and the soldering areas may be provided alternately on different sides of the conductor area with respect to a center line of the outer conductor.

It is preferable that the coaxial cable connecting board includes a connecting section, provided at a part of the cut section, which connects the conductor area surrounded by the cut section and the conductor area outside the cut section, the conductor area surrounded by the cut section and the conductor area outside the cut section being separated from each other by the cut section.

According to the arrangement, the soldering area is not completely separated by the cut section from the conductor area outside the cut section. Accordingly, this arrangement allows the soldering area to be electrically connected to the conductor area outside the cut section.

In the coaxial cable connecting board of the present embodiment, it is preferable that a through hole is provided at a position, on the conductor area, where the outer conductor is provided, so as to penetrate the coaxial cable connecting board between one and the other surfaces of the coaxial cable connecting board.

The arrangement makes it possible to electrically connect (i) a soldering area, where a soldering is carried out to the outer conductor, being electrically separated by the cut section from a conductor area outside the cut section, and (ii) the conductor area outside the cut section. This electrical connection is realized via (i) a through hole penetrating the connecting board so as to reach the surface on the other side of the connecting board and (ii) a conductor area on the surface on the other side of the connecting board. In other words, the soldering conductor area surrounded by the cut section can be electrically connected to the conductor area outside the cut section.

Moreover, because the outer conductor is provided on the through hole, solder does not go onto the other side of the connecting board when the outer conductor is soldered to the connecting board.

In the coaxial cable connecting board of the present embodiment, it is preferable that the cut section has a circular shape.

According to the arrangement, because the cut section has a circular shape, a surface tension applied to the solder at an end section of the cut section becomes soft because of the circular or arc shape. This can reduce an area on which the solder spreads on the ground pattern without deteriorating surface tension of the solder which surface tension occurs at the time when the solder spreads on the ground pattern.

In the coaxial cable connecting board, it is preferable that the coaxial cable is a semi-rigid cable.

According the arrangement, a semi-rigid cable can be used for wiring on the coaxial cable connecting board. When the semi-rigid cable deals with signals having a short wavelength, for example, a wavelength of UHF or SHF, transmission loss of the signals passing through the semi-rigid cable is smaller than that of signals passing through a general coaxial cable. Moreover, the semi-rigid cable structurally has a cable diameter which is smaller than that of the general coaxial cable.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A coaxial cable connecting board, on which surface a conductor area is formed, the conductor area, in which an outer conductor of a coaxial cable is soldered, being larger than a soldering area where a soldering is carried out to the outer conductor, said coaxial cable connecting board comprising:
a cut section, which is formed by paring off a periphery of the soldering area so that the conductor area is cut off,
the outer conductor being soldered in an area of the conductor area which area is surrounded by the cut section.

2. The coaxial cable connecting board as set forth in claim 1, wherein:
a through hole is provided, which penetrates the coaxial cable connecting board between the conductor area surrounded by the cut section on one side of the coaxial cable connecting board and a surface on the other side of the coaxial cable connecting board, so that
the conductor area surrounded by the cut section is electrically connected to the conductor area outside the cut section, via a conductor area on the other surface of the coaxial cable connecting board.

3. The coaxial cable connecting board as set forth in claim 1, wherein
the soldering area is provided on one of two parts into which a cross section of the outer conductor is divided by a center line; and
the soldering area is formed in at least an area surrounded by the outer conductor and the cut section.

4. The coaxial cable connecting board as set forth in claim 1, wherein
the soldering area is plurally provided in the conductor area, and the soldering areas are provided on the same side of the conductor areas with respect to a center line of the outer conductor.

5. The coaxial cable connecting board as set forth in claim 2, wherein
the soldering area is plurally provided in the conductor area, and the soldering areas are provided on the same side of the conductor areas with respect to a center line of the outer conductor.

6. The coaxial cable connecting board as set forth in claim 1, wherein
the soldering area is plurally provided in the conductor area, and the soldering areas are provided alternately on different sides of the conductor area with respect to a center line of the outer conductor.

7. The coaxial cable connecting board as set forth in claim 2, wherein
the soldering area is plurally provided in the conductor area, and the soldering areas are provided alternately on different sides of the conductor area with respect to a center line of the outer conductor.

8. The coaxial cable connecting board as set forth in claim 1, further comprising:
a connecting section, provided at a part of the cut section, which connects the conductor area surrounded by the cut section and the conductor area outside the cut section, the conductor area surrounded by the cut section and the conductor area outside the cut section being separated from each other by the cut section.

9. The coaxial cable connecting board as set forth in claim 2, further comprising:
a connecting section, provided at a part of the cut section, which connects the conductor area surrounded by the cut section and the conductor area outside the cut section, the conductor area surrounded by the cut section and the conductor area outside the cut section being separated from each other by the cut section.

10. The coaxial cable connecting board as set forth in claim 1, wherein
a through hole is provided at a position, on the conductor area, where the outer conductor is provided, so as to penetrate the coaxial cable connecting board between one and the other surfaces of the coaxial cable connecting board.

11. The coaxial cable connecting board as set forth in claim 1, wherein
the cut section has a circular shape.

12. The coaxial cable connecting board as set forth in claim 1, wherein
the coaxial cable is a semi-rigid cable.

13. A converter using a coaxial cable connecting board, on which surface a conductor area is formed, the conductor area, in which an outer conductor of a coaxial cable is soldered, being larger than a soldering area where a soldering is carried out to the outer conductor, said coaxial cable connecting board comprising:
a cut section, which is formed by paring off a periphery of the soldering area so that the conductor area is cut off,
the outer conductor being soldered in an area of the conductor area which area is surrounded by the cut section.

14. The converter as set forth in claim 13, the converter using the coaxial cable connecting board wherein:
a through hole is provided, which penetrates the coaxial cable connecting board between the area surrounded by the cut section on one side of the coaxial cable connecting board and a surface on the other side of the coaxial cable connecting board, so that
the area surrounded by the cut section is electrically connected to the conductor area outside the cut section conductor area, via a conductor area on the other surface of the coaxial cable connecting board.

15. The converter as set forth in claim 13, the converter using the coaxial cable connecting board further comprising:
a connecting section, provided at a part of the cut section, which connects the conductor area surrounded by the cut section and the conductor area outside the cut section, the conductor area surrounded by the cut section and the conductor area outside the cut section being separated from each other by the cut section.

16. The converter as set forth in claim 13, the converter using the coaxial cable connecting board, wherein
a through hole is provided at a position, on the conductor area, where the outer conductor is provided, so as to penetrate the coaxial cable connecting board between one and the other surfaces of the coaxial cable connecting board.

17. A high frequency apparatus using a coaxial cable connecting board, on which surface a conductor area is formed, the conductor area, in which an outer conductor of a coaxial cable is soldered, being larger than a soldering area where a soldering is carried out to the outer conductor, said coaxial cable connecting board comprising:
a cut section, which is formed by paring off a periphery of the soldering area so that the conductor area is cut off,
the outer conductor being soldered in an area of the conductor area which area is surrounded by the cut section.

18. The high frequency apparatus as set forth in claim 17, the high frequency apparatus using the coaxial cable connecting board wherein:
a through hole is provided, which penetrates the coaxial cable connecting board between the area surrounded by the cut section on one side of the coaxial cable connecting board and a surface on the other side of the coaxial cable connecting board, so that
the area surrounded by the cut section is electrically connected to the conductor area outside the cut section conductor area, via a conductor area on the other surface of the coaxial cable connecting board.

19. The high frequency apparatus as set forth in claim 17, the high frequency apparatus using the coaxial cable connecting board further comprising:
a connecting section, provided at a part of the cut section, which connects the conductor area surrounded by the cut section and the conductor area outside the cut section, the conductor area surrounded by the cut section and the conductor area outside the cut section being separated from each other by the cut section.

20. The high frequency apparatus as set forth in claim 17, the high frequency apparatus using the coaxial cable connecting board, wherein
a through hole is provided at a position, on the conductor area, where the outer conductor is provided, so as to penetrate the coaxial cable connecting board between one and the other surfaces of the coaxial cable connecting board.
